(19) United States
(12) Patent Application Publication
(10) Pub. No.: US 2025/0125454 A1
(43) Pub. Date: Apr. 17, 2025

(54) METHOD OF MANUFACTURING LAMINATE-TYPE BATTERY

(71) Applicant: TOYOTA JIDOSHA KABUSHIKI KAISHA, Toyota-shi (JP)

(72) Inventors: Kenichi KAKISHITA, Nagoya-shi (JP); Yusuke IKEDA, Miyoshi-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(21) Appl. No.: 18/822,298

(22) Filed: Sep. 2, 2024

(30) Foreign Application Priority Data
Oct. 17, 2023 (JP) 2023-179057

(51) Int. Cl. H01M 50/105

(52) U.S. Cl. CPC H01M 50/105

(57) ABSTRACT

A method of manufacturing a laminate-type battery is disclosed. The laminate-type battery includes an electrode body, a side member disposed at a side surface of the electrode body, and a laminate film covering the electrode body and a part of the side member, the side member being disposed at a position offset to a first side in a longitudinal direction of the side surface. The method includes a welding step of welding the laminate film so as to cover the electrode body and the part of the side member. In the laminate film used in the welding step, an average thickness of a region contacting a first region of the side member is larger than an average thickness of a region contacting a second region of the side member.

### CROSS-REFERENCE TO RELATED APPLICATION

This application is based on and claims priority under 35 USC 119 from Japanese Patent Application No. 2023-179057, filed on Oct. 17, 2023, the entire disclosure of which is incorporated by reference herein.

### BACKGROUND

### Technical Field

The present disclosure relates to a method of manufacturing a laminate-type battery.

### Related Art

Conventionally, laminate-type batteries have been used which include an electrode body, a side member such as a terminal, and a laminate film covering the electrode body and a part of the side member. In this laminate-type battery, in some cases, the side members are arranged at positions offset to one side with respect to the center of the side surface in the longitudinal direction of the side surface.

For example, Japanese Patent Application Laid-open No. H11-283611 discloses a battery in which a terminal on one side surface is arranged on the side surface so as to be offset to one side with respect to the center.

However, when the laminate film is welded to the electrode body at which the side member is arranged on the side surface so as to be offset to one side, in the laminate film in the region contacting the side member, there have been cases in which there have been differences in thickness depending on the location.

### SUMMARY

The present disclosure provides a method for manufacturing a laminate-type battery, which can reduce differences in thickness that occur depending on the location in a laminate film after welding contacting a side member.

The present disclosure includes the following aspects.

A first aspect of the present disclosure is a method of manufacturing a laminate-type battery, the laminate-type battery including: an electrode body; a side member disposed at a side surface of the electrode body; and a laminate film covering the electrode body and a part of the side member, the side member being disposed at a position offset to a first side in a longitudinal direction of the side surface relative to a center of the side surface in the longitudinal direction, the method including: a welding step of welding the laminate film so as to cover the electrode body and the part of the side member, wherein, in a case in which, with a center of the side member in the longitudinal direction of the side surface as a boundary, a region at the first side is designated a first region, and a region at a second side at an opposite side from the first side is designated a second region, in the laminate film used in the welding step, an average thickness of a region contacting the first region of the side member is larger than an average thickness of a region contacting the second region of the side member.

A second aspect of the present disclosure is the method of manufacturing a laminate-type battery of the first aspect, in which, in the laminate film used in the welding step, a thickness of a region contacting the side member continuously increases toward the first side in the longitudinal direction of the side surface.

A third aspect of the present disclosure is the method of manufacturing a laminate-type battery of the first aspect, in which, in the laminate film used in the welding step, a thickness of a region contacting the side member increases stepwise toward the first side in the longitudinal direction of the side surface.

According to the present disclosure, it is possible to provide a method of manufacturing a laminate-type battery in which differences in thickness that occur depending on the location in a laminate film after welding contacting a side member can be reduced.

### BRIEF DESCRIPTION OF THE DRAWINGS

An exemplary embodiment of the present disclosure will be described in detail based on the following figures, wherein:

FIG. 1 is a schematic perspective view showing the electrode body and the side member prior to performing a welding step in the method of manufacturing a laminate-type battery according to an embodiment of the present disclosure;

FIG. 2 is a schematic side view, seen from a side surface direction, showing a state prior to performing welding in a welding step in the method of manufacturing a laminate-type battery according to an embodiment of the present disclosure;

FIG. 3 is a schematic plan view showing relevant parts of a vehicle;

FIG. 4 is a schematic perspective view of a battery module;

FIG. 5 is a plan view of a state in which the upper lid of a battery module has been removed; and

FIG. 6 is a schematic view, seen from a thickness direction, of a battery cell housed in a battery module.

### DETAILED DESCRIPTION

An embodiment which is an example of the present disclosure will be described.

These descriptions illustrate embodiments and do not limit the scope of the invention. Note that the term “step” is included in the present terminology not only as indicating an independent step, but also to indicate a case in which the intended action of the step is achieved even if it cannot be clearly distinguished from other steps.

### Method of Manufacturing Laminate-Type Battery

A method of manufacturing a laminate-type battery according to an embodiment of the present disclosure produces a laminate-type battery that includes an electrode body, a side member arranged on a side surface of the electrode body, and a laminate film covering the electrode body and a part of the side member, the side member being arranged at a position that is offset to one side with respect to the center of the side surface in a longitudinal direction of the side surface.

The manufacturing method includes a step of welding a laminate film so as to cover the electrode body and a part of the side member.

In addition, in the side member, in a case in which, with the center of the side member in the longitudinal direction of the side surface as a boundary, the region at the side at which the side member is arranged to be offset is defined as the offset side region, and the other region is defined as the non-offset side region, in the laminate film used in the welding step, the average thickness of a region contacting the offset side region of the side member is greater than the average thickness of a region contacting the non-offset side region of the side member.

A method for manufacturing a laminate-type battery according to an embodiment of the present disclosure will now be described with reference to the drawings. The drawings shown below are schematically shown, and the sizes and shapes of the parts have been appropriately exaggerated for ease of understanding.

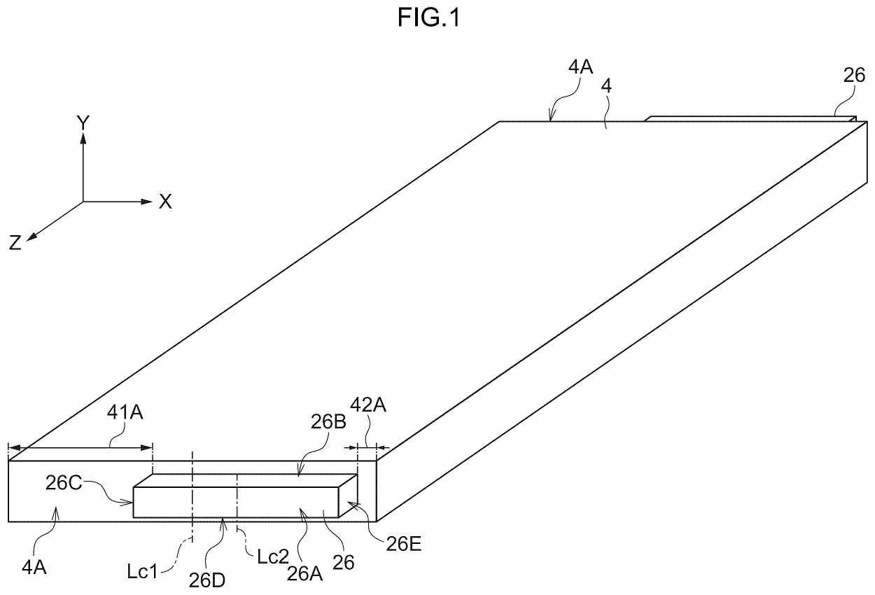

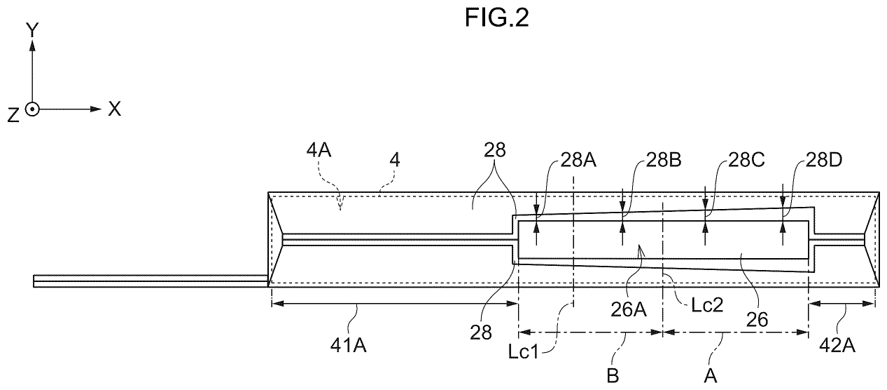

FIG. 1 is a schematic perspective view showing an electrode body and a side member before performing a welding step in the method for manufacturing a laminate-type battery according to an embodiment of the present disclosure. FIG. 2 is a schematic a side view, seen from a side surface direction (the direction of the surface at which the side member is arranged; the Z direction in FIG. 2), showing a state prior to performing welding in a welding step in the method of manufacturing a laminate-type battery according to an embodiment of the present disclosure.

As shown in FIG. 1, in the method for manufacturing a laminate-type battery according to an embodiment of the present disclosure, an electrode body 4 used in the welding step (i.e., before performing the welding step) has a terminal 26, as an example of a side member, provided on each of a pair of side surfaces 4A. Note that on the side surface 4A of the electrode body 4, there are two regions 41A and 42A, in which the terminal 26 is not arranged, at respective sides of the side surface 4A with the terminal 26 interposed therebetween in the longitudinal direction of the side surface 4A (the direction of arrow X).

One side in the longitudinal direction of the side surface 4A is defined as a first side, and the other side is defined as a second side. The terminal 26 is arranged at a position that is offset to the first side (a position offset to the right side in FIGS. 1 and 2) with respect to the center Lc1 of the side surface 4A in the longitudinal direction (the direction of arrow X) of the side surface 4A of the electrode body 4. Therefore, in the side surface 4A of the electrode body 4, the area of the region 42A at the first side (the side to which the terminal 26 is arranged to be offset) is smaller than that of the region 41A at the second side.

In the following description, among the two regions at which the side member is not arranged on the side surface of the electrode body, the region having the larger area is referred to as the “wide region”, and the region having the smaller area is referred to as the “narrow region”.

In addition, in the welding step in the method for manufacturing a laminate-type battery according to the embodiment of the present disclosure, as shown in FIG. 2, a laminate film 28 is arranged so as to cover the electrode body 4 and a part of the terminal 26. Note that FIG. 2 shows a state before welding is performed in the welding step. The laminate film 28 is arranged so as to cover the entire surface of the electrode body 4, and all of the regions on the side surface 4A of the electrode body 4 at which the terminal 26 is not provided are covered with the laminate film 28 (therefore, in FIG. 2, the electrode body 4 covered with the laminate film 28 is shown by a dotted line). Also, with respect to the terminal 26, the laminate film 28 is arranged to cover a part of each of the upper surface 26B, the left side surface 26C (one side surface along the direction of arrow Y, which is the transverse direction of the side surface of the electrode body), the lower surface 26D, and the right side surface 26E (the other side surface along the direction of arrow Y, which is the transverse direction of the side surface of the electrode body) of the terminal 26; more specifically, the region at the electrode body 4 side on these four surfaces. Accordingly, the entire surface of the outer side surface 26A of the terminal 26 and the region of the upper surface 26B, the left side surface 26C, the lower surface 26D, and the right side surface 26 at the opposite side from the electrode body 4 are not covered by the laminate film, and are exposed.

Furthermore, in the laminate film 28 used in the welding step (i.e., before the welding step is performed), a difference in thickness is provided depending on the location. Here, in the terminal 26, with the center Lc2 of the terminal 26 in the longitudinal direction of the side surface 4A (the direction of arrow X) as a boundary, a region on the first side (i.e., the narrow region side) is defined as a first region A (offset side region), and a region on the second side (i.e., the wide region side) at an opposite side from the first side is defined as a second region B (non-offset side region). In this case, in the laminate film 28 used in the welding step, the average thickness a of the region contacting the first region A of the terminal 26 is greater than the average thickness b of the region contacting the second region B of the terminal 26.

In the present disclosure, the average thickness a of the region of the laminate film contacting the first region A of the side member means an average of the thicknesses of the laminate film in regions contacting the first region A at two surfaces (the two surfaces that are the upper surface 26B and the lower surface 26D of the terminal 26 in FIG. 1) that are parallel to the longitudinal direction of the side surface of the electrode body, among the four surfaces of the side member contacting the laminate film (the four surfaces that are the upper surface 26B, the left side surface 26C, the lower surface 26D, and the right side surface 26E of the terminal 26 in FIG. 1).

Furthermore, the average thickness b of the region of the laminate film contacting the second region B of the side member means an average of the thicknesses of the laminate film in regions contacting the second region B at the two surfaces parallel to the longitudinal direction of the side surface of the electrode body among the four surfaces of the side member contacting the laminate film.

In this way, in the method for manufacturing a laminate-type battery according to the embodiment of the present disclosure, in the laminate film used in the welding step, the average thickness a of the region of the side member contacting the first region A is greater than the average thickness b of the region of the side member contacting the second region B. With this configuration, in the laminate film after welding contacting the side member, differences in thickness that occur depending on the location can be reduced.

Conventionally, laminate-type batteries have been used which comprise an electrode body, a side member such as a terminal, and a laminate film covering the electrode body and a part of the side member. Further, in this laminate-type battery, owing to the arrangement of batteries in a battery module, the side member may be arranged in a position offset to one side (the first side) with respect to the center of the side surface in the longitudinal direction of the side surface (the X direction in FIGS. 1 and 2).

Here, in the manufacture of laminate-type batteries, when sealing the electrode body and a part of the side member with the laminate film, the step of welding the laminate film so as to cover the electrode body and a part of the side member is performed. For example, at a position where the laminate film contacts the side member, by pressing a heated weld member against the side member via the laminate film, the inner surface of the laminate film (the side contacting the side member) is melted, and the laminate film is welded to the side member.

However, in a case in which the laminate film is welded to an electrode body in which the side member is arranged on the side surface so as to be offset to the first side, in the laminate film in the region contacting the side member, there have been cases in which there have been differences in thickness depending on the location. Specifically, in the laminate film in the region contacting the side member, the thickness of the laminate film has been reduced in the first region A, and on the other hand, in the second region B, the thickness of the laminate film has been increased. That is, in the laminate film in the region contacting the side member, the thickness of the laminate film is decreased at the narrow region side (the region at the side of the region 42A in FIGS. 1 and 2), while the thickness of the laminate film is increased at the wide region side (the region at the side of the region 41A in FIGS. 1 and 2). The reason for this is inferred to be as follows.

Since heat applied to the laminate film when welding the laminate film to the side member is absorbed by the side member or the electrode body, not all of the heat applied contributes to the melting of the inner surface of the laminate film. Further, in the electrode body in which the side member is arranged so as to be offset toward one side on the side surface of the electrode body, it is thought that a difference occurs in the amount of heat absorbed by the electrode body on one side and on the other side of the side member in the longitudinal direction of the side surface (the X direction in FIGS. 1 and 2). In other words, it is thought that on the side surface of the electrode body, in the side member closer to the wide region (i.e., the second region B), the amount of heat absorbed by the electrode body when the laminate film is welded increases, and in the side member on the side close to the narrow region (i.e., the first region A), the amount of heat absorbed by the electrode body decreases. This is presumed to be because the volume of the electrode body which contributes to heat absorption on the wide region side (i.e., the volume of the electrode body which is present in the vicinity of the second region B of the side member), is larger than the volume of the electrode body which contributes to heat absorption on the narrow region side (i.e., the volume of the electrode body which is present in the vicinity of the first region A of the side member). In the laminate film contacting the second region B of the side member, since the amount of heat absorbed by the electrode body is larger, the amount of heat contributing to the melting of the inner surface of the laminate film is reduced, and by reducing the amount melted, the thickness of the laminate film after welding is increased. On the other hand, in the laminate film contacting the first region A of the side member, since the amount of heat absorbed by the electrode body is smaller, the amount of heat that contributes to the melting of the inner surface of the laminate film increases, and by increasing the amount melted, the thickness of the laminate film after welding is reduced. According to the above mechanism, it is presumed that in the laminate film after welding in the region contacting the side member, a difference in thickness occurs depending on the location.

Therefore, in the method for manufacturing a laminate-type battery according to the embodiment of the present disclosure, in the laminate film used in the welding step, the average thickness a of the region contacting the first region A of the side member is made larger than the average thickness b of the region contacting the second region B of the side member. In other words, in the regions of the laminate film contacting the side member, the thickness of the region (i.e., the second region B) on the wide region side (in FIGS. 1 and 2, the left side) corresponding to the side where the thickness increases after welding is adjusted by reduction in advance, and the thickness of the region (i.e., the first region A) on the narrow region side (in FIGS. 1 and 2, the right side) corresponding to the side where thickness decreases after welding is adjusted by increase in advance. As a result, by adjusting the thickness of the regions contacting the side member of the laminate film in advance, differences in thickness in the laminate film after welding caused by differences in heat absorption by the electrode body can be offset. As a result, in the laminate film after welding contacting the side member, a difference in thickness depending on the location can be reduced.

In addition, in the method for manufacturing a laminate-type battery according to the embodiment of the present disclosure, in the laminate film used in the welding step, preferably, the thickness of the region contacting the side member increases continuously toward the first side in the longitudinal direction of the side surface.

In the laminate film 28 shown in FIG. 2, the thickness in the region contacting the terminal 26, in the longitudinal direction of the side surface 4A (the X direction in FIG. 2), is continuously increased from the region 41A side toward the region 42A side (i.e., the side to which the terminal 26 is arranged to be offset). Therefore, with respect to the region of the laminate film 28 contacting the terminal 26, in a case of having the point 28A, the point 28B, the point 28C, and the point 28D in this order from the side closer to the region 41A side, the thickness is increased in the order of the point 28A, the point 28B, the point 28C, and the point 28D.

As a result, in the laminate film used in the welding step, by continuously increasing the thickness of the region contacting the side member toward the first side in the longitudinal direction of the side surface, in the laminate film after welding contacting the side member, differences in thickness depending on the location can be further reduced.

Herein, a configuration in which the thickness in the region contacting the side member of the laminate film continuously increases toward the first side in the longitudinal direction of the side surface will be described. As used herein, “thickness” means the thickness of the laminate film in regions contacting the side member at two surfaces (the two surfaces that are the upper surface 26B and the lower surface 26D of the terminal 26 in FIG. 1) that are parallel to the longitudinal direction of the side surface of the electrode body, among the four surfaces of the side member contacting the laminate film (the four surfaces that are the upper surface 26B, the left side surface 26C, the lower surface 26D, and the right side surface 26E of the terminal 26 in FIG. 1). Therefore, among the regions of the laminate film contacting the side surface members, it is sufficient that the thickness of the two surfaces parallel to the longitudinal direction of the side surface (the upper surface 26B and the lower surface 26D in FIG. 1) continuously increases toward the first side (that is, toward the narrow region).

However, in the method for manufacturing a laminate-type battery according to the embodiment of the present disclosure, the laminate film used in the welding step does not have to have a configuration in which the thickness in the region contacting the side member continuously increases toward the first side in the longitudinal direction of the side surface. For example, the configuration may be such that the thickness in the region contacting the side member of the laminate film increases stepwise toward the first side in the longitudinal direction of the side surface (that is, a configuration in which the thickness gradually increases in a step-like manner).

### Measurement Method

Here, a method of measuring the average thickness a of the region of the laminate film contacting the first region A of the side member and the average thickness b of the region of the laminate film contacting the second region B of the side member will be described. As described above, the average thickness a of the region of the laminate film contacting the first region A of the side member means an average of the thicknesses of the laminate film in regions contacting the first region A at the two surfaces parallel to the longitudinal direction of the side surface of the electrode body among the four surfaces of the side member contacting the laminate film. Furthermore, the average thickness b of the region of the laminate film contacting the second region B of the side member means an average of the thicknesses of the laminate film in regions contacting the second region B at the two surfaces parallel to the longitudinal direction of the side surface of the electrode body among the four surfaces of the side member contacting the laminate film.

Further, for the average thickness a, the thickness of the laminate film in the region contacting the first region A at the two surfaces parallel to the longitudinal direction of the side surface of the electrode body among the four surfaces of the side member contacting the laminate film is measured at any ten positions, and the arithmetic average value thereof is used. On the other hand, for the average thickness b, the thickness of the laminate film in the region contacting the second region B at the two surfaces parallel to the longitudinal direction of the side surface of the electrode body among the four surfaces of the side member contacting the laminate film is measured at any ten positions, and the arithmetic average value thereof is used.

Next, a battery module, a battery pack, and a vehicle having a laminate-type battery manufactured by the method of manufacturing a laminate-type battery according to an embodiment of the present disclosure will be described with reference to the drawings.

### Overall Configuration of Vehicle 100

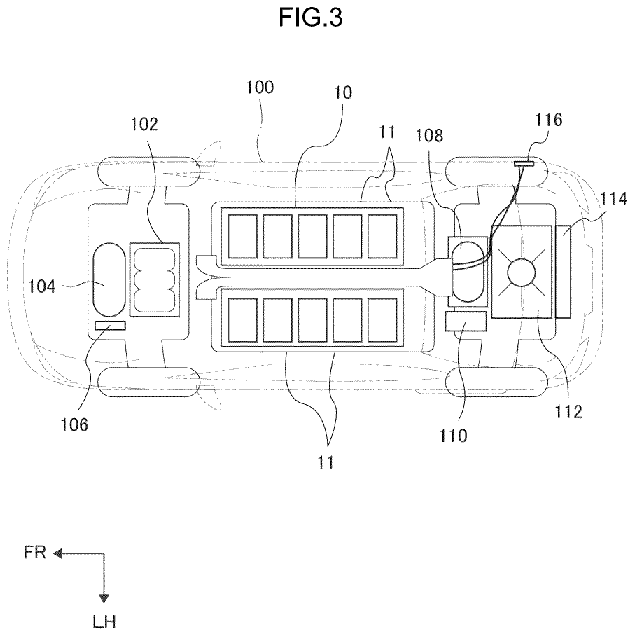

FIG. 3 is a schematic plan view showing the relevant parts of a vehicle 100 to which the battery pack 10 according to an embodiment is applied. As shown in FIG. 3, the vehicle 100 is an electric vehicle (BEV: Battery Electric Vehicle) in which a battery-pack 10 is installed under a floor. Note that arrows UP, FR, and LH in the drawings respectively indicate an upper side in the vehicle vertical direction, a front side in the vehicle front-rear direction, and a left side in the vehicle width direction. In cases in which description is made using front-rear, left-right, and up-down directions, unless otherwise specified, the front-rear, left-right, and up-down directions in the vehicle front-rear direction, the vehicle width direction, and the vehicle vertical direction are assumed to be indicated.

As an example, in the vehicle 100 of the present embodiment, a DC/DC converter 102, an electric compressor 104, and a PTC (Positive Temperature Coefficient) heater 106 are arranged closer to the vehicle front side than the battery pack 10. Furthermore, a motor 108, a gear box 110, an inverter 112, and a charger 114 are arranged on the vehicle rear side of the battery pack 10.

The DC current output from the battery pack 10 is adjusted for voltage by the DC/DC converter 102, and then supplied to the electric compressor 104, the PTC heater 106, the inverter 112, and the like. Further, as a result of supplying electric power to the motor 108 via the inverter 112, the rear wheel rotates to drive the vehicle 100.

A charging port 116 is provided at a right side part of the rear part of the vehicle 100, and by connecting the charging plug of an external charging facility (not shown) via the charging port 116, power can be stored in the battery pack 10 via the charger 114.

Note that the arrangement and structure of the components configuring the vehicle 100 are not limited to the configurations described above. For example, the present invention may be applied to an engine-mounted hybrid vehicle (HV: Hybrid Vehicle) or a plug-in hybrid vehicle (PHEV: Plug-in Hybrid Electric Vehicle). Furthermore, while, in the present embodiment, the vehicle is rear-wheel-driven with the motor 108 installed at the vehicle rear part, there is no limitation thereto, and the vehicle may be a front wheel drive vehicle with the motor 108 installed at the front part of the vehicle, or a pair of motors 108 may be installed at the front and rear of the vehicle. Furthermore, the vehicle may be provided with an in-wheel motor at each wheel.

Here, the battery pack 10 is configured to include plural battery modules 11. In the present embodiment, as an example, ten battery modules 11 are provided. Specifically, five battery modules 11 are arranged in the vehicle longitudinal direction on the right side of the vehicle 100, and five battery modules 11 are arranged in the vehicle longitudinal direction on the left side of the vehicle 100. Furthermore, each battery module 11 is electrically connected.

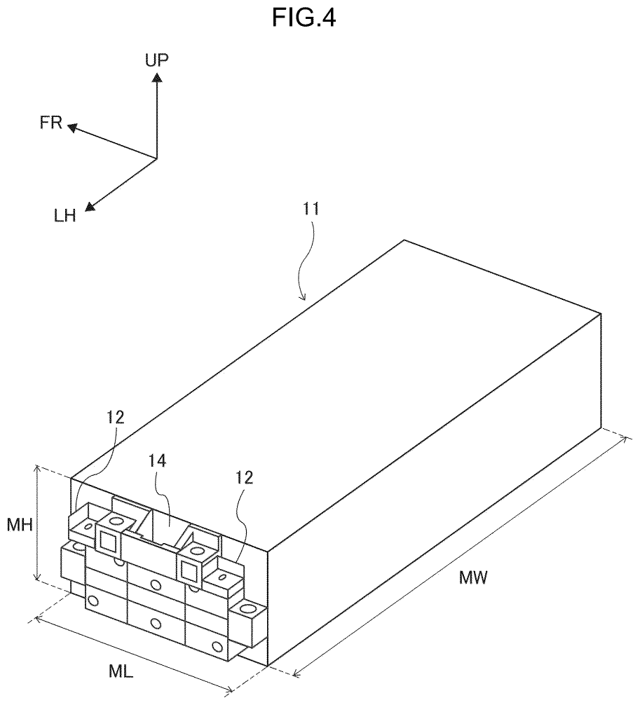

FIG. 4 is a schematic perspective view of the battery module 11. As shown in FIG. 4, the battery module 11 is formed in a substantially rectangular parallelepiped shape having a vehicle width direction as a longitudinal direction. Furthermore, the outer shell of the battery module 11 is formed of an aluminum alloy. For example, an outer shell of the battery module 11 is formed by joining aluminum die-casting to both ends of an extruded material of an aluminum alloy by laser welding or the like.

A pair of voltage terminals 12 and a connector 14 are provided at each end of the battery module 11 in the vehicle width direction. A flexible printed circuit board 22, which will be described later, is connected to the connector 14. Furthermore, bus bars (not illustrated) are welded to both ends of the battery module 11 in the vehicle width direction. The length MW of the battery module 11 in the vehicle width direction is, for example, 350 mm to 600 mm, the length ML in the vehicle front-rear direction is, for example, 150 mm to 250 mm, and the vehicle vertical direction height MH is, for example, 80 mm to 110 mm.

FIG. 5 is a plan view of the battery module 11 in a state in which the upper lid removed. The battery module 11 has battery cells 20 that are laminate-type batteries. As shown in FIG. 5, plural battery cells 20 are housed in the interior of the battery module 11 in an arrayed state. In the present embodiment, as an example, twenty-four battery cells 20 are arranged in the vehicle front-rear direction and adhered to each other.

A flexible printed circuit board (FPC: Flexible Printed Circuit) 22 is arranged over the battery cells 20. The flexible printed circuit board 22 is formed in a band shape with the vehicle width direction as its longitudinal direction, and thermistors 24 are provided at respective end parts of the flexible printed circuit board 22. The thermistor 24 is not adhered to the battery cells 20 and is configured to be pressed toward the battery cell 20 side by the upper lid of the battery module 11.

Furthermore, one or more cushioning materials (not illustrated) are housed inside the battery module 11. For example, the cushioning material is a thin plate-shaped member which is elastically deformable, and is arranged between adjacent battery cells 20 with the arrangement direction of the battery cells 20 as its thickness direction. In the present embodiment, as an example, cushioning materials are arranged at both end parts in the longitudinal direction of the battery module 11 and at the center part in the longitudinal direction, respectively.

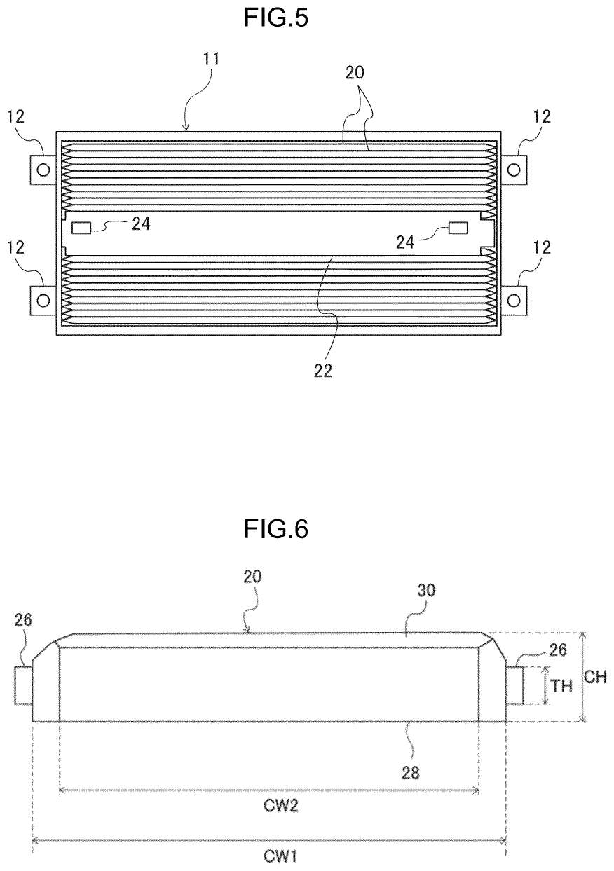

FIG. 6 is a schematic view of a battery cell 20 housed in the battery module 11 as viewed from its thickness direction. As shown in FIG. 6, the battery cell 20 is formed in a substantially rectangular plate shape, and an electrode body (not shown) is housed therein. The electrode body is configured by layering a positive electrode, a negative electrode, and a separator, and is sealed by a laminate film 28.

In the present embodiment, as an example, an embossed sheet-shaped laminate film 28 is folded and adhered together to form a housing part of the electrode body. Note that although both of a single-cup embossing structure in which one location is embossed and a double-cup embossing structure in which two locations are embossed can be adopted, in the present embodiment, the single-cup embossing structure has a drawing depth of about 8 mm to 10 mm.

The upper ends of both ends of the battery cell 20 in the longitudinal direction are bent, and the corners thereof form an outer shape. Furthermore, an upper end part of the battery cell 20 is bent, and a fixing tape 30 is wound around an upper end part of the battery cell 20 along the longitudinal direction.

Here, terminals (tabs) 26 are provided at respective ends in the longitudinal direction of the battery cell 20. In the present embodiment, as an example, the terminal 26 is provided at a position offset downward from the center of the battery cell 20 in the vertical direction. The terminal 26 is connected to a bus bar (not illustrated) by laser welding or the like.

The length CW1 of the battery cell 20 in the vehicle width direction is, for example, 530 mm to 600 mm, 600 mm to 700 mm, 700 mm to 800 mm, 800 to 900 mm, or 1000 mm or more; the length CW2 of the region in which the electrode body is housed is, for example, 500 mm to 520 mm, 600 mm to 700 mm, 700 mm to 800 mm, 800 to 900 mm, or 1000 mm or more; and the height CH of the battery cell 20 is, for example, 80 mm to 110 mm, or 110 mm to 140 mm. Furthermore, the thickness of the battery cell 20 is 5.0 mm to 7.0 mm, 7.0 mm to 9.0 mm, or 9.0 mm to 11.0 mm; and the height TH of the terminal 26 is 40 mm to 50 mm, 50 mm to 60 mm, or 60 mm to 70 mm.

What is claimed is:

1. A method of manufacturing a laminate-type battery, the laminate-type battery comprising:
an electrode body;
a side member disposed at a side surface of the electrode body; and
a laminate film covering the electrode body and a part of the side member,
the side member being disposed at a position offset to a first side in a longitudinal direction of the side surface relative to a center of the side surface in the longitudinal direction, the method comprising:
a welding step of welding the laminate film so as to cover the electrode body and the part of the side member, wherein,
in a case in which, with a center of the side member in the longitudinal direction of the side surface as a boundary, a region at the first side is designated a first region, and a region at a second side at an opposite side from the first side is designated a second region, in the laminate film used in the welding step, an average thickness of a region contacting the first region of the side member is larger than an average thickness of a region contacting the second region of the side member.

2. The method of manufacturing a laminate-type battery according to claim 1, wherein, in the laminate film used in the welding step, a thickness of a region contacting the side member continuously increases toward the first side in the longitudinal direction of the side surface.

3. The method of manufacturing a laminate-type battery according to claim 1, wherein, in the laminate film used in the welding step, a thickness of a region contacting the side member increases stepwise toward the first side in the longitudinal direction of the side surface.
